(19) United States
(12) Patent Application Publication
(10) Pub. No.: US 2004/0262796 A1
(43) Pub. Date: Dec. 30, 2004

(54) METHOD FOR FORMING MICROSTRUCTURE OPTICAL ELEMENTS

(76) Inventors: Chien-Hung Hsu, Miao-Li County (TW); Wen-Yung Huang, Miao-Li County (TW); Ruei-Jen Wang, Miao-Li County (TW); Yo-Chen Chen, Miao-Li County (TW); Chia-Hung Wu, Miao-Li County (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,708

(22) Filed: May 24, 2004

(30) Foreign Application Priority Data
Jun. 25, 2003 (TW) 092117396

(51) Int. Cl. B29D 11/00

(52) U.S. Cl. 264/2.5; 425/808

(57) ABSTRACT

The present invention provides a method for forming microstructure optical elements. The method comprises providing a mold and forming a cavity in the mold according to the shape of microstructure optical elements. The cavity is formed a sealed space, which is vacuumed through an extraction opening arranged near the end of the cavity. Filling material into the cavity is to be formed the microstructure optical elements. Due to an extraction opening arranged near the end of filling process, the filling process is smooth so as to improve the element quality, manufacturing efficiency and transferability.

### BACKGROUND OF INVENTION

1. Field of the Invention

The present invention relates to a method of forming, and more particularly to a method of forming a microstructure optical elements.

2. Description of the Prior Art

Microstructure optical elements have generally been used in photoelectric products. For example, a light guiding plate in LCD backlight module, Fresnel lens in projection optical system, etc. Under the consideration of manufacturing, low cost and high quality, the technique of forming optical elements is paid attention by the industry.

Please refer to FIG. 1 and FIG. 2, which are the conventional methods for forming microstructure optical elements by the following steps: (A) providing a forming mold 11 which are formed by a male mold 111 and a female mold 112 at first, and forming a cavity 113 between the male mold 111 and the female mold 112 according to the shape of the elements; (B) disposing a sprue 114 at one side of the cavity 113, and utilizing a latch mold device (not shown in the figures) to seal the forming mold 11; (C) injecting material into cavity 113 via a sprue 114; (D) opening the mold and taking out the formed product after the material is solidified.

However, the surface of the optical elements has plural rough microstructures and the area of the optical elements is large and the thickness is thin. Therefore, it is easy to disturb the flowing material and make flowing path too long thereafter causes bad filling, bad transferability and inaccurate microstructure of the product's surface. Besides, forming mold 11 with improper exhausting design makes air in the cavity 113 unable to exhaust efficiently. It causes bubbles on the surface of the formed products and influences optical feature due to bad quality of the optical elements. Therefore, the most popular solving manners in present are: (1) utilizing rising molds temperature to improve material's mobility, reduce the time for filling the molds to increase surface quality of the formed products. However, rising the temperature takes longer cooling time that takes longer total forming time and reduces the efficient of manufactory; (2) by rising material injecting speed, however, it is easy to have wrapping air or injection streak on formed products. Therefore, conventional methods of forming microstructure optical elements still have problems of inaccurate surface of the formed products and low manufactory efficiently to be solved.

### SUMMARY OF INVENTION

An object of the present invention is to provide a method for forming microstructure optical elements by placing an extraction opening at the end of cavity that is formed by filling. It makes the whole filling process keep the cavity vacuum and smooth.

Another object of the present invention is to provide a method for forming microstructure optical elements with extracting air from the opening via a slit between upper mold, lower mold, upper mold core or lower mold core in order to reduce waste material.

Another object of the present invention is to provide a method for forming microstructure optical elements by vacuuming the cavity that assists filling the material. It improves the quality of the formed products, manufacturing efficiency and transferability.

To achieve the above objects, the method for forming microstructure optical elements of the present invention is to provide a mold at first and forming a cavity in the mold according to the shape of microstructure optical elements. The cavity is formed a sealed space, which is vacuumed through an extraction opening arranged near the end of the cavity. Filling material into the cavity is to be formed the microstructure optical elements. Due to an extraction opening arranged near the end of filling process, the filling process is smooth so as to improve the element quality, manufacturing efficiency and transferability.

### BRIEF DESCRIPTION OF DRAWINGS

FIG. 1 is a flow chart of method for forming microstructure optical elements according to the conventional invention.

FIG. 2 is a perspective of the forming mold of microstructure optical elements according to the conventional invention.

FIG. 3A, FIG. 3B, FIG. 3C, FIG. 3D and FIG. 3E, are forming diagrams of microstructure optical elements according to the conventional invention.

FIG. 4, FIG. 5 and FIG. 6 are perspectives of forming methods of different kind of mold structure according to the conventional invention.

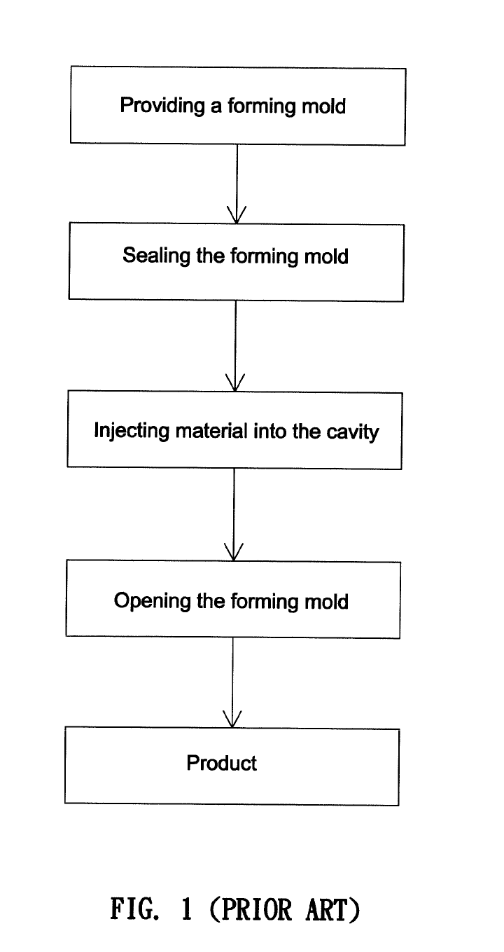

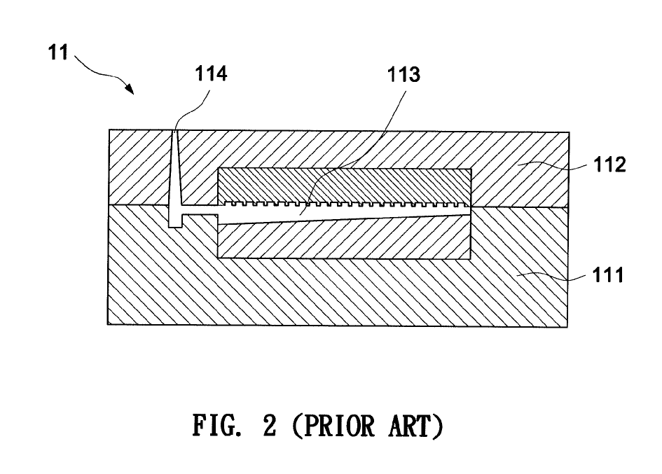

### DETAILED DESCRIPTION

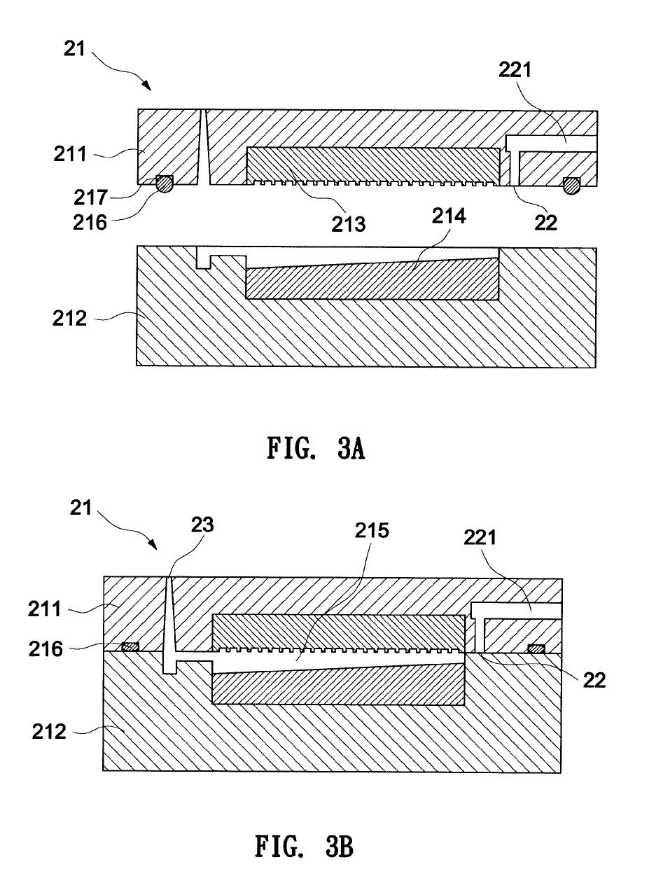

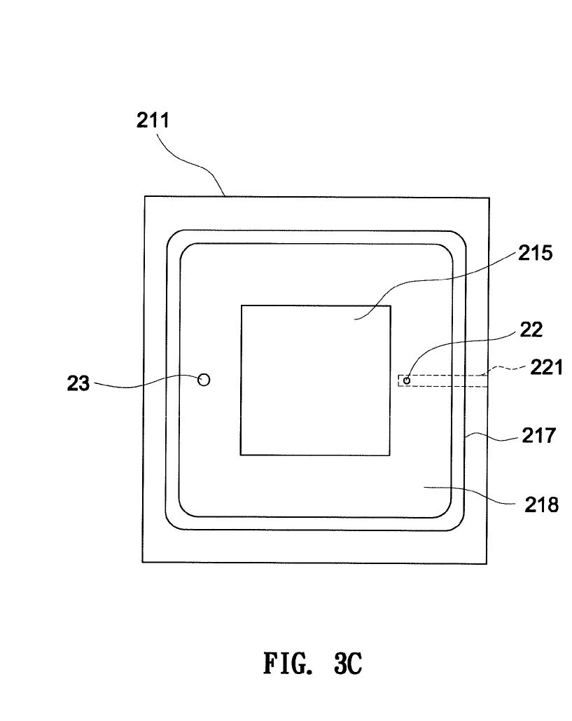

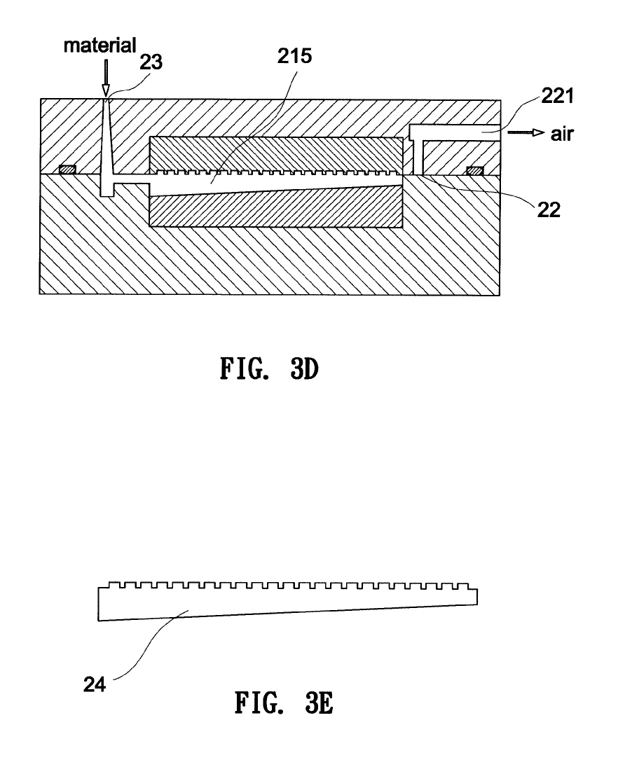

Referring to FIG. 3A to FIG. 3E, the steps of the method for forming microstructure optical elements of the present invention include: referring to FIG. 3A, first, providing a mold 21, said mold includes a matching pair, upper mold 211 and lower mold 212, and is disposed a upper mold core 213 and a lower mold core 214 inside the upper mold 211 and the lower mold 212 respectively; said upper mold core 213 and lower mold core 214 are microstructure thin film metal formed in electro-deposition manner and disposed a sealing component 216 on separating surface of the mold; said sealing component 216 is disposed at upper mold 211, lower mold 212 or between upper and lower mold; there can also be disposed a trench 217 for placing the sealing component 216 and said sealing component 216 is a O-ring. Referring to FIG. 3B, after the upper mold 211 and the lower mold 212 are closed, it forms a sealed space 218 (as shown in FIG. 3C) inside the mold 21 by the sealing component 216, and forms a cavity 215 between the upper mold core 213 and the lower mold core 214.

Refer to FIG. 3C, there is an extraction opening 22 disposed near the end of the formed cavity 215 in the sealing space 218; said extraction opening 22 is disposed between the upper mold 211 and the lower mold 212; and also connect to an extraction path 221 which has another end connected to a vacuum equipment outside the cavity 215 (not shown in the Fig.); the cavity 215 keeps negative pressure vacuum condition via the extraction opening 22, the extraction path 221 and the vacuum equipment to process vacuum step. The position of the extraction opening 22 is not directly connected to the cavity 215 but through the slit inside the mold to exhaust air within the cavity 215, therefore, it can avoid waste material filling inside the extraction opening 22 or the extraction path 221 during filling process. Thus, it can reduce the forming of waste material.

Referring to FIG. 3D, finally, a sprue 23 is disposed at one side of the cavity 215, the opposite side of the extraction opening 22. Material to be formed fills into the cavity 215 through the extraction opening 22. The forming way is injecting, casting or transfer molding. Open the mold after the material is solidified, the microstructure optical elements product 24 will be obtained (as shown in FIG. 3E).

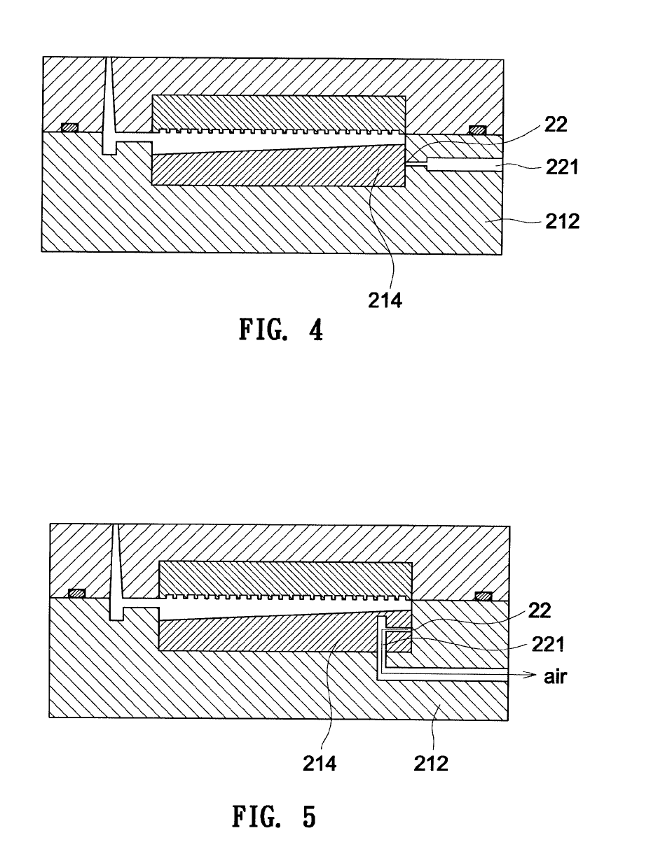

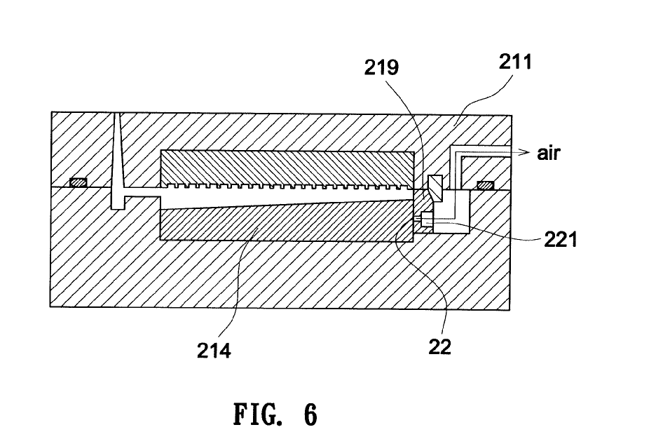

Furthermore, said extraction opening 22 and said extraction path 211 may have different design according to the mold. For example, as shown in FIG. 4, an extraction opening 22 is disposed between the lower mold core 214 and the lower mold 212, and an extraction path 221 is disposed at the lower mold 212; as shown in FIG. 5, an extraction opening 22 is disposed between the lower mold core 214 and the lower mold 212 and an extraction path 221 is disposed between the lower mold core 214 and the lower mold 212; as shown in FIG. 6, a sliding block 219 is disposed in the mold 21 that an extraction opening 22 is disposed between the sliding block 219 and the lower mold core 214, and an extraction path 221 is disposed between the sliding block 219 and the upper mold core 211, and extraction path 221 is disposed above slide block 219 and upper mold 211.

During material filling process, the cavity 215 is vacuumed through the extraction opening 22. It increases flowing ability of material to assist the material filling and also renders air inside the cavity 215 to be vacuumed. It improves the quality of formed products, manufacturing efficiency and transferability; and said extraction opening 22 is disposed at the end of the formed cavity to avoid material from stocking the extraction opening 22 and unable to extract during the filling process. Therefore, the present invention of the forming manner can make sure that the cavity 215 stably keeps vacuum during the filling process. It makes the filling process smooth to improve the high quality and transferability of formed products.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for forming microstructure optical elements, comprising the following steps:
(A) providing a mold and forming a cavity in the mold according to the shape of microstructure optical elements;
(B) forming a sealed space in said cavity;
(C) vacuuming through an extraction opening arranged near the end of the formed cavity inside said sealed space; and
(D) filling the material to be formed into the cavity and obtaining microstructure optical elements.

2. The method for forming microstructure optical elements as claimed in claim 1, wherein in step (A), the mold includes a upper mold and a lower mold, and an upper mold core and a lower mold core are disposed inside the upper mold and the lower mold respectively, and then the upper mold and the lower mold are closed to form said cavity between the upper mold core and the lower mold core.

3. The method for forming microstructure optical elements as claimed in claim 1, wherein in step (B), a sealing component is disposed on separated surface of the mold forming a sealed space in the cavity.

4. The method for forming microstructure optical elements as claimed in claim 1, wherein said extraction opening vacuums the cavity into a vacuum condition.

5. The method for forming microstructure optical elements as claimed in claim 1, wherein said extraction opening is disposed around said mold core.

6. The method for forming microstructure optical elements as claimed in claim 1, wherein said extraction opening is disposed on separating surface of said mold.

7. The method for forming microstructure optical elements as claimed in claim 1, wherein said extraction opening could connect extraction path and vacuum equipment.

8. A forming mold with microstructure optical elements comprising:
a pair of upper mold and lower mold forming a cavity between said upper mold and said lower mold;
a sealing element disposed between said upper mold and said lower mold forming a sealed space in the cavity;
an extraction opening disposed around the end of said formed cavity.

9. The forming mold with microstructure optical elements as claimed in claim 8, wherein a pair of upper mold core and lower mold core is disposed inside said cavity.

10. The forming mold with microstructure optical elements as claimed in claim 8, wherein said sealing element is an O-ring.

11. The forming mold with microstructure optical elements as claimed in claim 8, wherein an extraction path is disposed at one side of said extraction opening.

12. The forming mold with microstructure optical elements as claimed in claim 8, wherein said extraction opening is disposed between the upper mold and the lower mold of said mold.

13. The forming mold with microstructure optical elements as claimed in claim 9, wherein said extraction opening is disposed between the upper mold and the upper mold core.

14. The forming mold with microstructure optical elements as claimed in claim 9, wherein said extraction opening is disposed between the lower mold and the lower mold core.
